(19) United States
(12) Patent Application Publication
(10) Pub. No.: US 2025/0305449 A1
(43) Pub. Date: Oct. 2, 2025

(54) DISTRIBUTED NEW ENERGY INTEGRATED DISPATCHING SYSTEM COMBINING GAS TURBINE AND OPTICAL STORAGE

(71) Applicant: NEPU SANYA OFFSHORE OIL&GAS RESEARCH INSTITUTE, Sanya (CN)

(72) Inventors: Chengqin Li, Sanya (CN); Xiaofei Fu, Sanya (CN); Xiaobo Liu, Sanya (CN); Jianxiong Kang, Sanya (CN); Yufeng Cui, Sanya (CN); Yuqi Zhang, Sanya (CN)

(73) Assignee: NEPU SANYA OFFSHORE OIL&GAS RESEARCH INSTITUTE, Sanya, HI (CN)

(21) Appl. No.: 19/239,872

(22) Filed: Jun. 16, 2025

(30) Foreign Application Priority Data
Jan. 23, 2025 (CN) 202510112086.5

(51) Int. Cl. F02C 6/18; F28D 20/00; H02K 7/18; H02S 10/30

(52) U.S. Cl. CPC F02C 6/18; F28D 20/0056; H02K 7/1823; H02S 10/30; F05D 2220/76

(57) ABSTRACT

The invention discloses a distributed new energy integrated deployment system combining gas turbine and optical storage, belonging to the field of gas turbine technology. The system includes a gas turbine, wherein the inner side of the gas turbine comprises a compressor, a combustion chamber, a turbine and a generator, and wherein the compressor and the combustion chamber are connected to a photothermal system. The exhaust end of the turbine is connected to a waste heat utilization system, and the output end of the generator is connected to a power supply system. The invention constitutes a distributed new energy comprehensive deployment system combining gas turbine and optical storage, which can realize efficient, clean, flexible, and economical energy supply, promote the wide application of renewable energy, and the transformation of energy structure.

### TECHNICAL FIELD

The invention relates to the technical field of gas turbines, especially to a distributed new energy integrated deployment system combining gas turbines and optical storage.

### BACKGROUND

Among existing technologies, with the increasingly serious problems of environmental pollution and energy shortage, as well as the defects of traditional large-capacity centralized power supply, distributed generation technology has attracted more and more attention. With its unique advantages, distributed generation has become a promising energy utilization method in the new energy power generation industry. Rational development and utilization of distributed generation has become an important measure to improve the economics and stability of power grid operation. Many electric power experts and scholars domestically and internationally believe that the integration of distributed generation systems into a large power grid system is a method that can effectively reduce energy consumption and improve the reliability and flexibility of the power grid. The integration of distributed generation into the power grid is the future development direction of China's power industry.

Nowadays, industrial production methods featuring large-scale, high energy consumption, and high carbon emissions are undergoing transformation in order to save energy and reduce carbon emissions in accordance with the overall development trends of the digital economy. Therefore, the problems of high energy consumption and insufficient waste heat utilization in traditional industrial production processes need to be solved urgently.

### SUMMARY

The purpose of the invention is to provide a distributed new energy integrated deployment system combining gas turbines and optical storage, which can realize efficient, clean, flexible, and economical energy supply, and promote the wide application of renewable energy and the transformation of energy infrastructure.

In order to achieve the above purpose, the invention provides a distributed new energy integrated deployment system combining a gas turbine and optical storage. The system includes a gas turbine, wherein the inner side of the gas turbine comprises a compressor, a combustion chamber, a turbine and a generator, and wherein the compressor and the combustion chamber are connected to a photothermal system, an exhaust end of the turbine is connected to a waste heat utilization system, and an output end of the generator is connected to a power supply system.

Preferably, the photothermal system includes a photothermal module and a heat storage tank, wherein a heat exchanger is arranged inside the heat storage tank; an output end of the compressor is connected to a cold air input end of the heat exchanger through a pipeline, and a hot air output end of the heat exchanger is connected to an air input end of the combustion chamber through the pipeline.

Preferably, an output end of the compressor is connected to the air input end of the combustion chamber through the pipeline and a first valve is installed on the pipeline, a second valve is installed on the pipeline between the cold air input end of the compressor and the heat exchanger, a third valve is installed on the pipeline between the hot air output end of the heat exchanger and the air input end of the combustion chamber.

Preferably, the heat storage tank is a tank using a new solid particle heat storage medium, and a heat storage temperature is 950° C.

Preferably, the waste heat utilization system includes at least one of a waste heat lithium bromide unit, a waste heat hot water boiler, an ORC generator, and a waste heat steam boiler.

Preferably, a steam output end of the waste heat steam boiler is connected to a steam turbine.

Preferably, an output end of the generator is connected to an energy storage system.

Preferably, the power supply system and the energy storage system are connected to a power end.

Therefore, the beneficial effect of the distributed new energy integrated deployment system combining the above gas turbine and optical storage is as follows:

(1) Energy supply system stability: The whole system uses a gas turbine as the only energy conversion device. The gas turbine can switch the energy source of the front end at any time according to the actual situation (when the light and heat are sufficient, the light and heat are used, and when the light and heat are insufficient, the fuel is used). Compared with the system using photovoltaic and wind energy, its stability is higher, and the power quality is high; it does not require a large power grid or a large amount of energy storage to stabilize the volatility of renewable energy.

(2) It realizes multi-energy complementation and comprehensive energy supply: the fuel end can be supplied in a variety of energy modes (solar energy, diesel oil, methanol, hydrogen, associated gas, etc., flexibly deployed according to customer site conditions) to improve the flexibility and stability of the system. The output end realizes the output of electricity, cold/heat, steam, and other energy sources, and the comprehensive energy efficiency of the system is greatly improved.

(3) Taking into account environmental protection and flexibility: when switching to fuel, both methanol and hydrogen can be used to reduce dependence on fossil fuels, thereby reducing greenhouse gas emissions and promoting environmental protection; diesel and associated gas can also be used to improve the adaptability of distributed new energy integrated deployment system.

(4) In the light shortage or peak load period, the gas turbine can be quickly activated to ensure the continuity and reliability of power supply.

(5) By reducing the dependence on traditional energy, the operating costs are reduced, the energy efficiency is improved, and the economic efficiency is enhanced.

(6) Through the ability of the energy storage system to be regulated, it is helpful to balance the load of the microgrid and improve the stability and safety of the whole power system.

(7) It is conducive to promoting the development and application of related technologies, and promoting the progress of new energy and smart grid technologies.

The following is a further detailed description of the technical scheme of the invention through drawings and implementation examples.

### BRIEF DESCRIPTION OF THE DRAWINGS

FIG. 1 is a structural diagram of an implementation example of the distributed new energy integrated deployment system combining gas turbine and optical storage.

Reference marks in the FIGURES:
1, gas turbine; 2, photothermal module; 3, heat storage tank; 4, heat exchanger; 5, first valve; 6, second valve; 7, third valve; 8, compressor; 9, combustion chamber; 10, turbine; 11, generator; 12, power supply system; 13, energy storage system; 14, power end; 15, waste heat utilization system; 16, waste heat lithium bromide unit; 17, waste heat hot water boiler; 18, ORC generator; 19, waste heat steam boiler; 20, steam turbine.

### DETAILED DESCRIPTION OF THE EMBODIMENTS

The following is a further explanation of the technical scheme of the invention through drawings and implementation examples.

Unless otherwise defined, the technical terms or scientific terms used in the invention should be understood by people with general skills in the field to which the invention belongs. The words ‘first’, ‘second’, and the like used in this invention do not represent any order, quantity, or importance, but are only used to distinguish different components. Similar words such as ‘includes’ or ‘including’ mean that the elements or objects appearing before the word cover the elements or objects listed after the word and their equivalents, without excluding other elements or objects. Similar terms such as ‘connected’ or ‘connecting’ are not limited to physical or mechanical connections, but can include electrical connections, whether direct or indirect. ‘Up’, ‘down’, ‘left’, ‘right’, etc, are only used to represent the relative positional relationship. When the absolute position of the described object changes, the relative positional relationship may also change accordingly.

### Implementation Example One

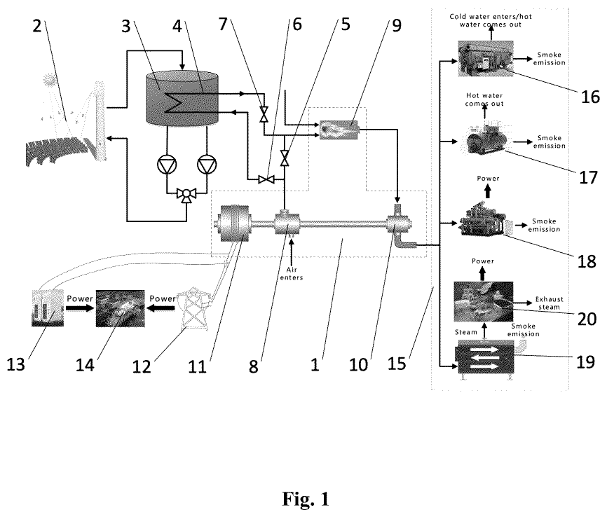

As shown in FIG. 1, the invention provides a distributed new energy integrated deployment system combining gas turbine and optical storage, including a gas turbine 1. The gas turbine 1 is a common structure in traditional existing technologies. The inner side of the gas turbine 1 includes a compressor 8, a combustion chamber 9, a turbine 10, a generator 11 and corresponding temperature and pressure sensors, because they are all existing technologies, there is no need to elaborate too much.

In this implementation example, a photothermal system is connected between the compressor 8 and the combustion chamber 9, which can heat the high-pressure gas discharged from the compressor 8 to a certain extent. The photothermal system includes a photothermal module 2 and a heat storage tank 3, wherein the heat storage tank 3 is a tank body using a new generation of a solid particle heat storage medium. A ‘new generation’ solid particle heat storage medium is a system that is capable of maintaining its heat storage temperature is as high as 950° C., compared with the heat storage temperature of 650° C. in the traditional heat storage tank. The new generation solid particle heat storage system can achieve longer and larger energy storage, and the energy generated by photothermal module 2 can be used more efficiently. The heat storage tank 3 can effectively store the heat converted by the photothermal module 2,

The heat exchanger 4 is arranged inside the heat storage tank 3, and the output end of the compressor 8 is connected to the cold air input end of the heat exchanger 4 through the pipeline. The hot air output end of the heat exchanger 4 is connected to the air input end of the combustion chamber 9 through the pipeline. This structure can allow the high-pressure gas discharged from the compressor 8 to fully exchange heat with the heat storage tank 3, so that the air entering the combustion chamber 9 has a higher initial temperature, which can reduce the use of fuel to a certain extent.

In addition, the output end of compressor 8 is connected to the air input end of combustion chamber 9 through the pipeline and a first valve 5 is installed on the pipeline. A second valve 6 is installed on the pipeline between the cold air input end of the compressor 8 and the heat exchanger 4, and the third valve 7 is installed on the pipeline between the hot air output end of heat exchanger 4 and the air input end of combustion chamber 9. It can be seen from the above structure that by changing the opening or closing state of different valves, the path of high-pressure gas discharged from compressor 8 can be changed, so that the adjustment of different working modes of the whole system can be realized.

The exhaust end of turbine 10 is connected to the waste heat utilization system 15, through the waste heat utilization system 15. Thus, the waste gas discharged from turbine 10, which still has high temperature and high pressure, can be reused again, so as to realize the full utilization of energy, improve the efficiency of energy utilization and enhance the economic benefits.

The waste heat utilization system 15 includes at least one of the waste heat lithium bromide unit 16, waste heat hot water boiler 17, ORC generator 18, and waste heat steam boiler 19. The steam output end of the waste heat steam boiler 19 is connected to a steam turbine 20.

The output end of the generator 11 is connected to the power supply system 12 and the energy storage system 13. The power supply system 12 and the energy storage system 13 are connected to the power end 14. In the actual use process, according to the actual power demand of the power end 14, the redundant power of the power generated by the gas turbine 1 is stored in the energy storage system 13. When the power end 14 needs power, it is preferentially transferred from the energy storage system 13, which can realize the reasonable scheduling of energy and avoid the waste of energy.

The specific operation strategies are as follows:

(1) When the light and heat are sufficient, the medium in the heat storage tank 3 is heated to a high temperature state by the light and heat module 2, the first valve 5 is closed, the second valve 6 and the third valve 7 are opened, and the high-pressure gas from the compressor 8 directly enters the heat storage tank 3, the heat exchanger 4 heats up after heat exchange with the high-temperature heat storage medium, and the gas then enters the combustion chamber 9, and then enters the turbine 10 from the combustion chamber 9 and drives the generator 11 to work and output power to the outside world. At the same time, the gas from the tail of turbine 10 has a certain temperature after work, which can drive the waste heat utilization system 15 for secondary utilization, so as to realize the comprehensive allocation and utilization of energy. During the operation, the actual required temperature condition of the turbine 10 can be assessed in real time according to the power demand of the power end 14, and then the combustion state of the fuel in the combustion chamber 9 can be adjusted to meet the power supply demand.

(2) When the light and heat is insufficient, the first valve 5 opens, the second valve 6 and the third valve 7 close, the high pressure gas from the compressor 8 directly into the combustion chamber 9, so that the high pressure gas has a small pressure attenuation, through the fuel (can be diesel, methanol, hydrogen, associated gas) combustion heating, and the high pressure gas then enters the turbine 10 and promote the generator 11 work, to output power to the outside world. At the same time, the gas from the tail of turbine 10 has a certain temperature after work, which can still drive the waste heat utilization system 15 for secondary utilization, so as to realize the comprehensive allocation and utilization of energy.

Therefore, the invention adopts a distributed new energy integrated deployment system combining gas turbine and optical storage, which can realize efficient, clean, flexible, and economical energy supply, and promote the wide application of renewable energy and the transformation of energy structure.

Finally, it should be explained that the above embodiment is only used to explain the technical scheme of the invention, rather than restricting it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A distributed new energy integrated deployment system combining gas turbine and optical storage, comprising:
a gas turbine, wherein an inner side of the gas turbine comprises a compressor, a combustion chamber, a turbine and a generator;
wherein the compressor and the combustion chamber are connected to a photothermal system,
wherein an exhaust end of the turbine is connected to a waste heat utilization system, and
wherein an output end of the generator is connected to a power supply system.

2. The distributed new energy integrated deployment system combining gas turbine and optical storage according to claim 1, wherein,
the photothermal system comprises a photothermal module and a heat storage tank, and a heat exchanger is arranged inside the heat storage tank;
wherein an output end of the compressor is connected to a cold air input end of the heat exchanger through a pipeline, and a hot air output end of the heat exchanger is connected to an air input end of the combustion chamber through the pipeline.

3. The distributed new energy integrated deployment system combining gas turbine and optical storage according to claim 2, wherein,
an output end of the compressor is connected to the air input end of the combustion chamber through the pipeline and a first valve is installed on the pipeline,
wherein a second valve is installed on the pipeline between the cold air input end of the compressor and the heat exchanger, and a third valve is installed on the pipeline between the hot air output end of the heat exchanger and the air input end of the combustion chamber.

4. The distributed new energy integrated deployment system combining gas turbine and optical storage according to claim 2, wherein,
the heat storage tank is a tank using a new solid particle heat storage medium, and a heat storage temperature is 950° C.

5. The distributed new energy integrated deployment system combining gas turbine and optical storage according to claim 1, wherein,
the waste heat utilization system includes at least one of a waste heat lithium bromide unit, a waste heat hot water boiler, an ORC generator, and a waste heat steam boiler.

6. The distributed new energy integrated deployment system combining gas turbine and optical storage according to claim 5, wherein,
a steam output end of the waste heat steam boiler is connected to a steam turbine.

7. The distributed new energy integrated deployment system combining gas turbine and optical storage according to claim 1, wherein,
an output end of the generator is connected to an energy storage system.

8. The distributed new energy integrated deployment system combining gas turbine and optical storage according to claim 7, wherein,
the power supply system and the energy storage system are connected to a power end.
